(19) United States
(12) Patent Application Publication
(10) Pub. No.: US 2026/0260472 A1
(43) Pub. Date: Sep. 3, 2026

(54) Method and Apparatus for Benchmarking and Boosting 3D Segmentation Models

(71) Applicants: Madhumitha SARAVAN, Tempe, AZ (US); Nahid UI ISLAM, Mesa, AZ (US); Jiaxuan PANG, Tempe, AZ (US); Jianming LIANG, Scottsdale, AZ (US)

(72) Inventors: Madhumitha SARAVAN, Tempe, AZ (US); Nahid UI ISLAM, Mesa, AZ (US); Jiaxuan PANG, Tempe, AZ (US); Jianming LIANG, Scottsdale, AZ (US)

(73) Assignee: Arizona Board of Regents on Behalf of Arizona State University, Scottsdale, AZ (US)

(21) Appl. No.: 19/555,592

(22) Filed: Mar. 3, 2026

Related U.S. Application Data
(60) Provisional application No. 63/766,286, filed on Mar. 3, 2025.

(51) Int. Cl. G06V 10/774; G06V 10/26; G06V 10/764; G06V 10/778; G06V 10/82; G06V 20/50

(52) U.S. Cl. CPC G06V 10/7747; G06V 10/26; G06V 10/764; G06V 10/778; G06V 10/82; G06V 20/50; G06V 2201/031

(57) ABSTRACT

Training a deep learning model for diverse, three-dimensional image segmentation tasks involves receiving a plurality of heterogeneously labeled three-dimensional image data sets and learning features of images in the plurality of heterogeneously labeled three-dimensional image data sets, via a three-dimensional image segmentation framework that operates using a single, shared, image encoder. Learning the features of the images comprises performing, via the image encoder, a classification task to learn image-level features in the images, a segmentation task to learn pixel-level features in the images, and a localization task to learn regional-level features in the images.

### CLAIM OF PRIORITY

This application claims the benefit of U.S. Provisional Patent Application No. 63/766,286, filed Mar. 3, 2025, entitled “BENCHMARKING AND BOOSTING OF 3D SEGMENTATION MODELS”, the disclosure of which is incorporated by reference herein in its entirety.

### GOVERNMENT RIGHTS AND GOVERNMENT AGENCY SUPPORT NOTICE

This invention was made with government support under R01 HL128785 awarded by the National Institutes of Health. The government has certain rights in the invention.

### COPYRIGHT NOTICE

A portion of this document contains material which is subject to copyright protection. The copyright owner has no objection to the facsimile reproduction by anyone of the document as it appears in the Patent and Trademark Office patent records, but otherwise reserves all copyright rights whatsoever.

### TECHNICAL FIELD

The disclosed embodiments relate to three-dimensional image segmentation via a multi-task machine learning model.

### BACKGROUND

Deep learning has the potential to transform medical diagnosis, surgery, and therapy by automating organ and tumor segmentation. However, annotating datasets for training these models is labor-intensive, often leading to small and inconsistent datasets. This limitation has hindered the development of robust and versatile models, frequently resulting in single-task models that specialize in only one task. This situation has created two main challenges. First, the prevalence of numerous single-task models without a current benchmark makes it difficult to select the best model for a specific task, potentially leading to suboptimal performance. Second, the development of generalizable models through multi-task learning utilizing heterogeneous datasets has encountered issues like catastrophic forgetting, extensive preprocessing requirements, and difficulties in scaling to new tasks.

### BRIEF DESCRIPTION OF THE DRAWINGS

Embodiments are illustrated by way of example, and not by way of limitation, and can be more fully understood with reference to the following detailed description when considered in connection with the figures in which:

FIG. 1 graphically illustrates the comparison between the performance of state-of-the-art single-task 3D segmentation models.

FIG. 2 presents Table 1 which demonstrates a comparison of the mean Dice Score Coefficient (DSC) of state-of-the-art single-task 3D segmentation models for CT and MRI datasets.

FIG. 3A depicts the performance of state-of-the-art single-task 3D segmentation models on smaller organs in the BTCV.

FIG. 3B depicts the performance of state-of-the-art single-task 3D segmentation models on smaller organs in AMOS.

FIGS. 4A and 4B illustrate how the boosting framework uses multiple heads for different target tasks and employs a student-teacher architecture to stabilize training and preserve knowledge.

FIGS. 5A and 5B demonstrate that the disclosed embodiments improved notably in identifying smaller organs during pre-training and performed well on unique labels in the AMOS dataset.

FIG. 6A illustrates a comparison of performance on duodenum in AMOS with the performance of the disclosed embodiments.

FIG. 6B illustrates a comparison of performance on the bladder in AMOS with the performance of the disclosed embodiments

FIG. 6C illustrates a comparison of performance on the prostate in AMOS with the performance of the disclosed embodiments.

FIG. 7A illustrates focused and unfocused testing performance on BTCV in BTCV-AMOS pre-training.

FIG. 7B illustrates focused and unfocused testing performance on AMOS in BTCV-AMOS pre-training.

FIG. 7C illustrates focused and unfocused testing performance on BTCV in BTCV-LiTS pre-training.

FIG. 7D illustrates focused and unfocused testing performance on LiTS in BTCV-LiTS pre-training.

FIG. 8 presents Table 2 which shows performance scores for the disclosed embodiments, pre-trained on 16 public datasets for 200 epochs.

FIG. 9 presents performance scores from the few-shot fine-tuning experiment on the TotalSegmentator dataset for the Organs task.

### DETAILED DESCRIPTION

This disclosure presents a comprehensive benchmark that identifies MedNeXt and U-Mamba_Bot as the top performers for 3D single-task segmentation with limited data. Additionally, embodiments of the disclosure employ Cyclic, Lock, and Release pre-training strategies to develop a multi-task model capable of joint learning from multiple heterogeneous datasets. This model leverages a shared encoder to integrate knowledge across tasks while incorporating task-specific components to address the unique attributes of each task. The resulting model, pre-trained on 16 public datasets with 3,000 CT scans annotated for 25 organs and 6 tumors, outperformed both the single-task Swin UNETR and the multi-task CLIP-driven Universal model and exhibited superior generalization and data efficiency when fine-tuned on the TotalSegmentator dataset. The model's exceptional performance stems from its ability to learn jointly from expert annotations without requiring alterations while preventing task bias and minimizing forgetting, providing an approach that rivals current state-of-the-art solutions.

### 1. Introduction

Deep learning is transforming healthcare, especially in medical diagnostics and therapy, by automating the segmentation of organs and tumors. This advancement relies on expert-annotated datasets, which are often small due to the labor-intensive annotation process. Single-task models like nnU-Net, Swin UNETR, MedNeXt and U-Mamba have been developed for segmentation tasks associated with these limited individual datasets. Selecting the right model is essential to achieving optimal results, and this disclosure establishes a benchmark to evaluate both recent and established models in 3D medical image segmentation.

While single-task models excel at segmenting specific organs, they struggle with new task labels due to diverse and incomplete annotations in smaller datasets. For example, the LiTS dataset includes annotations only for the liver and liver tumors, while the labels in AbdomenCT1k dataset covers just the liver, kidney, stomach, and pancreas. These partial labels with inconsistent label indices across datasets hinder the creation of a generalized model that integrates knowledge across different tasks. To address these issues, various multi-task partial-label learning techniques have been developed. However, these methods face challenges such as the risk of forgetting previously learned information, high GPU memory usage, and limited scalability to new tasks. Consequently, this disclosure explores the question: Is it possible to develop an end-to-end model that collaboratively learns from multiple small, unaltered expert-annotated datasets, adapts to new tasks, and reduces the risk of catastrophic forgetting?

To this end, the disclosed embodiments provide a model that employs strategies from Ma et al., “Foundation Ark: Accruing and Reusing Knowledge for Superior and Robust Performance” in Medical Image Computing and Computer Assisted Intervention—MICCAI 2023, pages 651-662, Cham, 2023, Springer Nature Switzerland, and Islam et al., “Foundation X: Integrating Classification, Localization, and Segmentation through Lock-Release Pretraining Strategy for Chest X-ray Analysis.” in Proceedings of the IEEE/CVF Winter Conference on Applications of Computer Vision, 2025 to learn both task-invariant and task-specific features. The disclosed embodiments include a shared backbone to integrate diverse task features while allowing task-specific components to focus on unique aspects. This design facilitates easy addition of new task heads, enhancing scalability, and improving contextual relationships and task differentiation, leading to better performance than baseline models, especially with sufficient training data. In cases with limited data, the disclosed embodiments provide similar performance to baseline models.

The disclosed embodiments effectiveness in 3D image segmentation is demonstrated through large-scale pre-training on 16 heterogeneous, partially labeled datasets, consisting of 3,000 CT scans annotated for 25 organs and 6 tumors. The disclosed model out-performed both single-task Swin UNETR models and the multi-task CLIP-driven Universal model. The disclosed embodiments also excelled in few-shot fine-tuning on the unseen TotalSegmentator dataset, showcasing strong generalization and data efficiency.

In summary, this disclosure provides the following contributions:
1. Benchmarking single-task models in 3D medical image segmentation, identifying MedNext and U-Mamba_Bot as top performers.
2. Developing a collaborative end-to-end model that learns from diverse expert-annotated datasets, according to the disclosed embodiments.
3. Providing results that highlight the disclosed embodiments'superior performance, generalization, and data efficiency.
The disclosed embodiments'effectiveness stems from the ability to learn from diverse datasets without extensive pre-processing. By using task-specific heads and a novel learning strategy, the disclosed embodiments enhance scalability, retain knowledge, and reduce task bias.

### 2. Related Work

Multi-decoder models like Med3D represent the first category of multi-task partial-label learning techniques, utilizing multiple lightweight decoders for different segmentation tasks. While effective, this approach significantly increases the parameter count, leading to higher computational demands and memory usage, which can affect scalability. These models may also struggle with catastrophic forgetting, resulting in decreased performance on prior tasks when new ones are introduced.

The second category includes task-guided dynamic convolution techniques like DoDNet. These models generate filters based on input data and task specificity but can only predict two labels—organ and tumor—requiring multiple forward passes for datasets with numerous organs. Scalability is limited by the need for task encoding adjustments and retraining.

The third category features two-stage or multi-stage models that use partially and fully annotated labels. They generate high-quality pseudo-labels in initial stages, which are then refined with ground truth labels. However, they often face inefficiencies in knowledge transfer and scalability due to their reliance on pseudo-labels.

Finally, text-conditioned strategies integrate textual prompts with image features to influence outputs. Models like CLIP-driven Universal and UniSeg utilize these prompts, but require expert-level label adjustments, limiting scalability and creating challenges due to gaps between natural image tasks and medical segmentation.

In contrast, a model according to the disclosed embodiments eliminates extensive preprocessing and features parameter-efficient, task-specific heads that can be easily scaled by adding new ones as needed. The disclosed embodiments reduce memory overload and allow for proportional parameter increases based on feature size. The cyclic learning strategy according to the disclosed embodiments also enhances knowledge retention, minimizing catastrophic forgetting.

As noted in Sec. 1, the disclosed embodiments are based on the learning strategies from Foundation Ark by Ma et al. and Foundation X by Islam et al. Unlike Foundation Ark's focus on 2D classification and Foundation X's emphasis on 2D function integration, the disclosed embodiments focus on 3D segmentation tasks.

### 3. Benchmarking Single-Task 3D Segmentation Models

The availability of expert-annotated datasets has accelerated the development of deep learning models for segmentation tasks. Pure convolutional networks like nnU-Net continue to demonstrate high effectiveness in medical image segmentation.

Building on the success of transformers in Natural Language Processing, researchers have adapted this architecture for vision tasks by applying it to sequences of image patches. They have found that pre-training on larger datasets can significantly enhance the performance of transformers, often surpassing that of traditional convolutional models. Hybrid models such as Swin UNETR and nnFormer integrate features from both architectures, while refined designs like MedNeXt and STU-Net improve long-range spatial dependencies without relying on transformer blocks.

Ma et al. developed U-Mamba_Bot and U-Mamba_Enc as extensions of the Mamba model, which excels at processing sequential inputs. These models combine Mamba blocks with convolutional networks to achieve enhanced segmentation accuracy.

Standalone transformer models like Swin U-Net were excluded from the disclosed embodiments for two reasons. First, they require converting 3D datasets into 2D slices, leading to a loss of important spatial information. Second, their use with 3D images results in longer sequences, increasing computational complexity and making them impractical.

Given the vast range of available models, selecting the appropriate model for specific tasks is essential to avoid suboptimal outcomes. This disclosure evaluates the strengths and limitations of seven advanced single-task models for segmenting organs and lesions in the brain, abdomen, and chest, using CT and MRI datasets.

### 3.1 Both MedNeXt and U-Mamba_Bot Excelled Equally Across 3D Segmentation Tasks

Experimental Setup: This disclosure analyzes single-task models by categorizing them into broad groups and selecting representative models. The nnU-Net framework was used to customize model configurations for six datasets. Pre-processing followed the MICCAI 2023 guidelines with a patch size of 128×128×128 and spacing of 1×1×1. Post-processing was conducted solely for the BraTS task, based on Baid et al.'s, “The RSNA-ASNR-MICCAI BraTS 2021 Benchmark on Brain Tumor Segmentation and Radiogenomic Classification” 2021 instructions. All models, except STUNet and U-Mamba, were implemented using the first version of the nnU-Net framework. Additionally, new data points have been added to the AMOS dataset since its initial release, which were not included in the MedNeXt training reported by Roy et al. “MedNeXt: Transformer-Driven Scaling of ConvNets for Medical Image Segmentation,” in Lecture Notes in Computer Science, International Conference on Medical Image Computing and Computer-Assisted Intervention (MICCAI), Springer, 2023. To assess the statistical significance of the results, a 5-fold cross-validation with a fixed seed was employed, which allowed creation of five unique folds for each dataset. Each model was trained from scratch and validation scores were calculated for the final checkpoint across all folds. The final performance score was derived by averaging these scores.

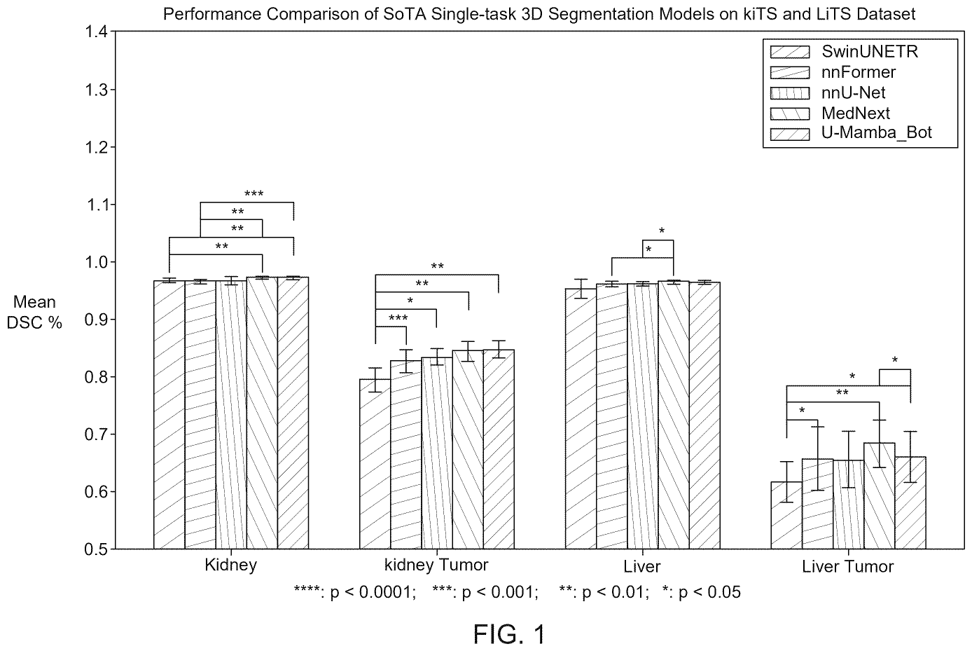

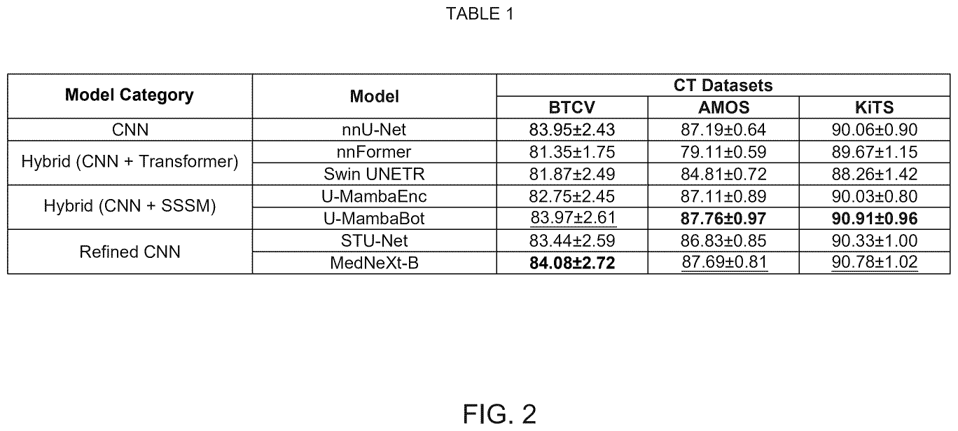

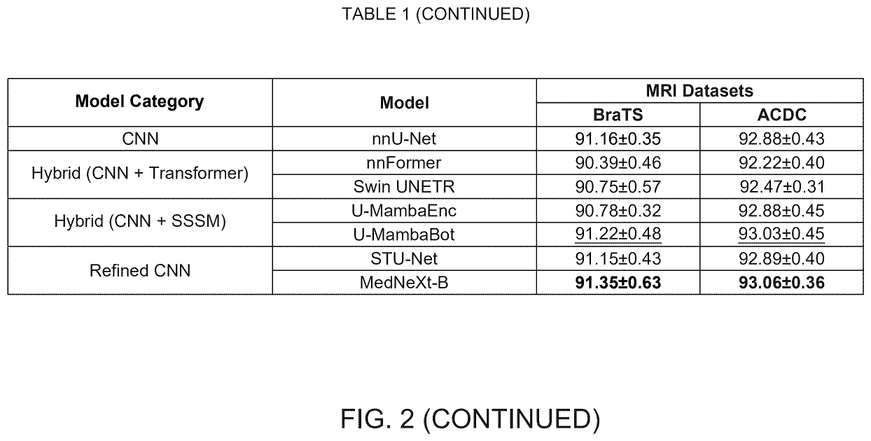

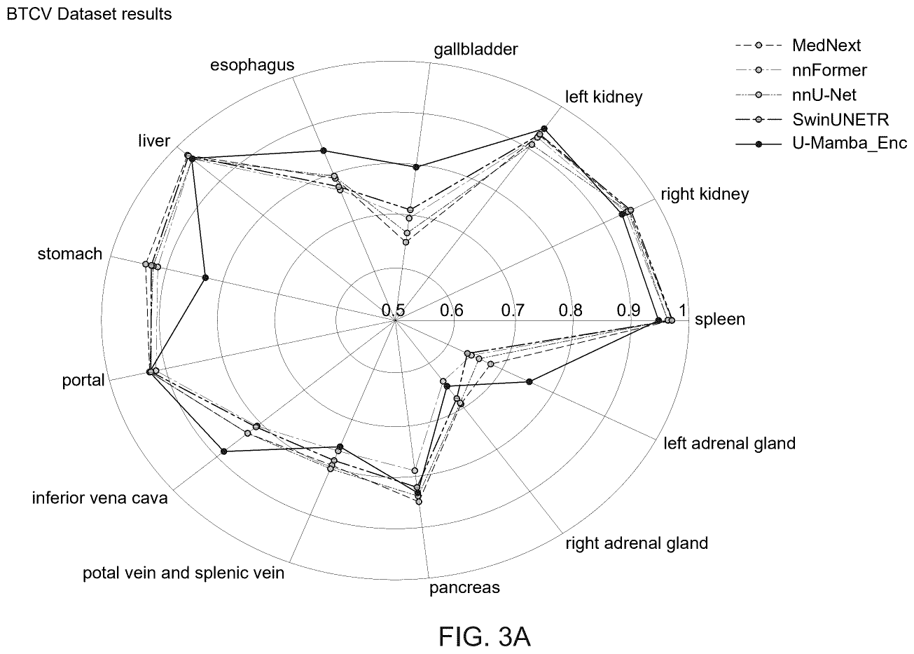

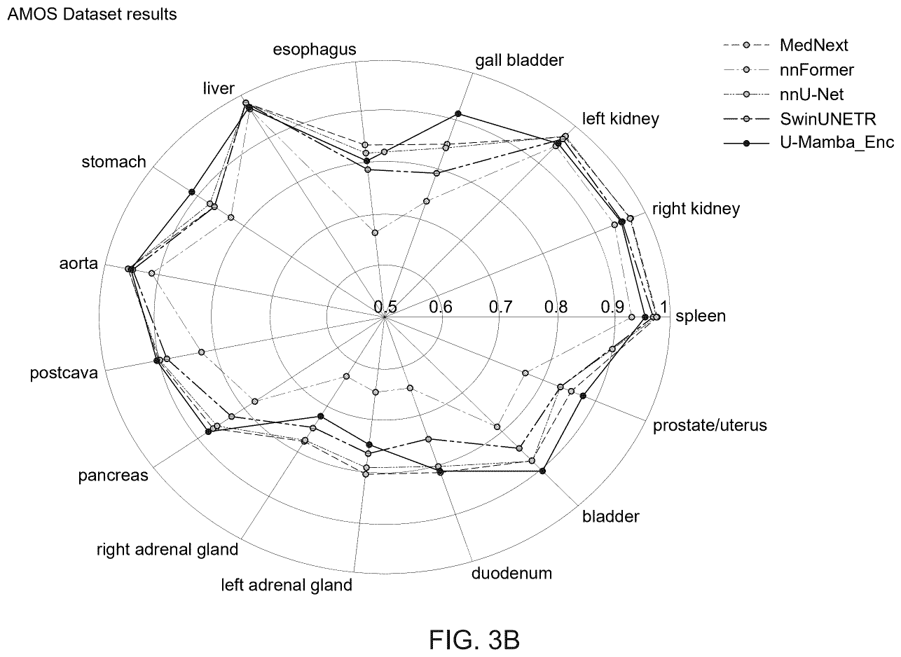

Observation and Analysis: The evaluations revealed that nnU-Net consistently outperformed CNN-transformer hybrids such as SwinUNETR and nnFormer. STUNet excelled over nnU-Net in three tasks due to its scalability, while the customizable U-Net architecture of nnU-Net sometimes yielded superior results. Med-NeXt, a refined CNN based on the ConvNeXt framework, surpassed both nnU-Net and STUNet across all six tasks, largely because of its use of larger kernels that enhance long-range spatial learning. The U-Mamba_Bot model, a hybrid based on CNN-SSM, outperformed MedNeXt and five other models in two tasks and matched MedNeXt's performance in one, meanwhile MedNeXt excelled in the remaining tasks. Both models effectively leverage convolutional layers for inductive biases and offer long-range spatial learning. The U-Mamba_Enc model, another CNN-SSM hybrid, demonstrated strong performance but was slightly outperformed by U-Mamba_Bot likely due to its lower parameter count. Overall, MedNeXt and the U-Mamba variants exhibited robust performance across various tasks, including tumor segmentation, as seen in FIG. 1 and TABLE 1, presented in FIG. 2. FIG. 1 compares the performance of state-of-the-art single-task 3D segmentation models across KiTS and LiTS segmentation tasks. Due to variations in size and disease progression among patients, tumor segmentation is notably challenging. MedNeXt and U-Mamba Bot consistently excel in segmenting these complex structures. TABLE 1, presented in FIG. 2, compares the mean Dice Score Coefficient (DSC) of state-of-the-art single-task 3D segmentation models for CT and MRI datasets. The top score for each task is in boldface type font, while the second highest score is underlined. MedNeXt led in four cases, and U-Mamba_Bot excelled in the other two. FIGS. 3A and 3B compare the performance of state-of-the-art single-task 3D segmentation models in the BTCV and AMOS segmentation tasks. The U-Mamba variant and MedNeXt outperformed others in segmenting smaller organs. They highlight that U-Mamba particularly excelled in segmenting smaller organs, while MedNeXt maintained consistent performance, even when U-Mamba variants faced challenges with some smaller organs.

### 4. Boosting 3D Segmentation Via Multi-Task Learning

Enhancing 3D segmentation methodologies and facilitating generalization involves a robust representation learning framework that effectively utilizes diverse expert annotations while preserving information integrity. This framework adapts to new tasks without compromising established knowledge and ensures fairness across varying complexity levels. It seeks to establish a foundational model capable of amassing a comprehensive knowledge base. It is achieved through the exhaustive utilization of complementary knowledge from classification, segmentation, and localization functions.

To achieve this, the disclosed embodiments adopt the large-scale pre-training framework termed “Cyclic, Lock, and Release pre-training strategies” This framework encompass three learning paradigms: Cyclic pre-training strategy, Lock-Release pre-training strategy and Student-Teacher learning. Employing the Swin UNETR model, the disclosed embodiments create a tailored version specifically for 3D medical image segmentation. The model features a single shared encoder and decoder to capture common and complementary features. The model's distinct heads for each task allow independent optimization and mitigate task interference, enhancing adaptability and scalability.

The pre-training framework operates using a single, shared image encoder to capture the complexities of an image at different functional levels. The classification task aims to comprehend image-level features, while the segmentation and localization tasks seek to do the same at the pixel and regional levels within an image. As a result, the integrated image encoder focuses on learning features that are common and complementary to each of these functions and sub-tasks. The original foundational model has a Swin-B backbone for learning the shared features.

In addition, the framework suggests employing distinct components tailored to each task to learn and refine task-specific features. This approach ensures that each task or function can be optimized independently of the others. The foundational model includes a shared backbone encoder and the following components for each function:
1. Classification Function: Several linear classifiers designed to learn features that are unique to each classification task.
2. Segmentation Function: A singular decoder equipped with multiple heads to discern task-specific features in segmentation tasks, employing the Uper-Net architecture as the segmentor.
3. Localization Function: A single transformer encoder, accompanied by multiple transformer decoders and heads, to decouple task-specific features efficiently. Here, the DINO (DETR with Improved deNoising anchOr boxes) architecture serves as the localizer.

Consequently, by employing distinct modules to handle shared and task-specific attributes, this framework facilitates resistance towards the phenomenon of task interference—a predominant challenge in the domain of multi-task learning. Moreover, it significantly enhances the pre-training framework's adaptability to novel tasks, thus ensuring elevated scalability across various tasks.

The objective is to devise a comprehensive learning strategy tailored for 3D segmentation tasks by incorporating this framework. The Swin UNETR 3D model is used to effectively integrate the pre-training framework. The choice of Swin UNETR is grounded in its demonstrated state-of-the-art performance in the CLIP-driven Universal model, which leveraged this architecture for large-scale pre-training across 16 datasets. This selection ensures a fair comparison with the CLIP-driven Universal model while allowing assessment of the impact of the boosting framework independently of more advanced models like MedNeXt and U-Mamba Bot, which are top performers in single-task 3D segmentation. Consequently, any observed performance gains can be attributed exclusively to the pre-training technique rather than the model architecture itself. In summary, the choice of Swin UNETR as the backbone stems from its successful integration in the state-of-the-art CLIP-driven Universal model, which excels in multi-task learning. This approach allows for a fair comparison by isolating the effects of advanced models like MedNeXt and U-Mamba_Bot. This way, one can attribute performance gains directly to the pre-training technique, demonstrating the strength of the methodology even without advanced models.

### 4.1 Knowledge-Centric Cyclic Pre-Training Strategy

Learning from heterogeneous datasets poses challenges due to label inconsistencies, as noted by Liu et al. “CLIP-Driven Universal Model for Organ Segmentation and Tumor Detection,” in 2023 IEEE/CVF International Conference on Computer Vision (ICCV), pages 21095-21107, 2023. These issues can arise from mismatched indices, differing terminologies, and missing labels, requiring substantial domain knowledge for effective manual alignment without compromising expert insights.

Ma et al.'s cyclic pre-training strategy allows the model to learn from diverse datasets using task-specific heads without manual consolidation. This method revisits each task in every cycle, preserving previous knowledge and reducing the risk of catastrophic forgetting, while also enhancing learning efficiency. Additionally, this addresses the cross-institutional domain gap introduced by annotation variability across institutions and promotes patient population diversification during training.

### 4.2 Task-Equilibrated Lock-Release Pre-Training Strategy

A significant challenge in multi-task training is task prioritization, where a model may favor one task or overfit to it, especially when using heterogeneous datasets that differ in size and labeling. The goal is for the model to develop a strong understanding of each task, allowing for effective generalization and the recognition of shared features. This understanding helps establish relevance and connections among tasks, making it crucial to avoid overfitting.

To tackle this, the disclosed embodiments use the Lock-Release pre-training strategy by Islam et al. In “Lock mode,” the model's backbone and decoder are frozen to fine-tune only the task-specific heads with half of the dataset, reducing early overfitting. This approach enables the model to concentrate on learning a single task while retaining the shared features. During this phase, training is carried out using only a random half of the task dataset to prevent early overfitting and to refine the focus. In “Release mode,” the model becomes fully trainable, learning shared and task-specific features from the entire dataset. It comprehensively learns shared features across tasks and grasps task-specific variations through the acquisition of task-specific features. This phase involves thorough training on the complete task dataset to establish a comprehensive learning process.

During “Lock mode,” the model leverages high-level features from previous layers. It learns to adapt to a new task by utilizing only the high-level features specific to that task from the previously learned low-level layers. This enables the model to understand inter-task relationships. Transitioning to “Release mode” allows it to update these inter-task relationships before returning to “Lock mode.” This balanced approach prevents excessive specialization in any single task in a multi-task learning situation.

### 4.3 Knowledge-Preserving Student-Teacher Learning Paradigm

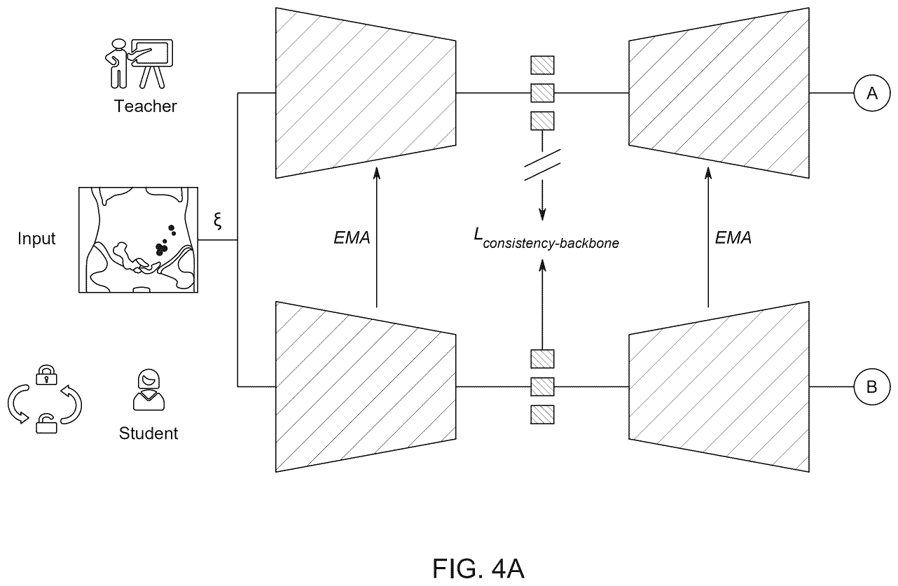

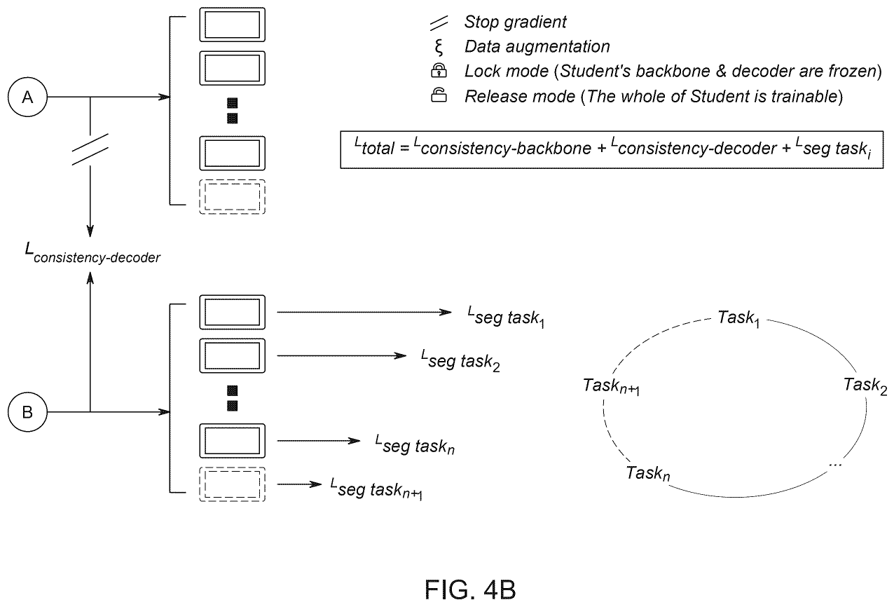

FIGS. 4A and 4B illustrate that the boosting framework uses multiple heads for different target tasks and employs a student-teacher architecture to stabilize training and preserve knowledge according to the disclosed embodiments. A teacher model, with the same architecture as the student model, is initialized with identical weights. The weights of the student model are updated using standard training methods via loss backpropagation. Meanwhile, the weights of the teacher model are updated using an exponential moving average (EMA) of the student's weights. This method involves cyclically freezing and unfreezing the student model's encoder-decoder, enabling it to focus on one task per epoch while maintaining relationships with previous tasks. This approach ensures balanced learning across all tasks.

To retain and reinforce previously acquired knowledge while preventing catastrophic forgetting, this framework uses a student-teacher learning paradigm based on the mean teacher approach by Tarvainen et al. “Mean teachers are better role models: Weight-averaged consistency targets improve semi-supervised deep learning results,” Advances in Neural Information Processing Systems, Vol. 30, 2017. Both the teacher and student models have the same architecture and initial weights. The student model's weights are adjusted through loss backpropagation, while the teacher model's weights are updated using an exponential moving average (EMA), allowing for gradual accumulation of knowledge. After pre-training, the teacher model is used for fine-tuning.

This approach ensures stable learning and effective generalization across diverse tasks by applying consistency losses between the student and teacher models, focusing on features from their backbones and decoders. It helps the model recognize that a specific organ may be represented by different label indices across tasks, enhancing its ability to reconcile these representations and build a cohesive knowledge repository. Consequently, this method captures contextual relationships between features linked to different organs, addressing the orthogonality issue noted by Liu et al, which limits multi-channeled task heads in understanding inter-feature relationships.

### 4.4 Experiments and Results

### 4.4.1 Implementation Details

The modified Swin UNETR architecture was initialized, excluding the task-specific heads with the self-supervised learning weights provided by Hatamizadeh et al. “Swin UNETR: Swin Transformers for Semantic Segmentation of Brain Tumors in MRI Images,” International MICCAI Brain Lesion Workshop, Springer, 2021, pp. 272-284. The task-specific heads were initialized randomly. Two versions of this model were trained-one version using all 16 datasets employed in pre-training the current state-of-the-art multi-task CLIP-driven Universal model and another version using four of those 16 datasets including BTCV, LiTS, Abdomen CT 1K and AMOS. The experiments followed the train-validation-test splits provided by Liu et al. except for the BTCV dataset. Specifically, the official test scans were excluded from BTCV's training split, resulting in a cohort of 24 CT scans. The same data augmentation techniques and hyperparameters as Liu et al. were used, with one exception: the Random Crop (Patch) Size. This size was set to 128×128×128. The pre-training process was carried out using a single A100 GPU.

### 4.4.2 Boosting Framework Offers Cross-Task Learning and Comprehensive Understanding

Experimental Setup: This experiment aimed to showcase the effectiveness of the framework, which uses Cyclic, Lock, and Release pre-training strategies to enhance shared representations, comprehension, and generalization. The experiments demonstrate how the model integrates knowledge from multiple tasks, a process referred to as cross-task learning. The model was pre-trained on four datasets. Each training cycle involves training on one dataset in Lock mode during epoch x and then in Release mode during epoch x+1, repeating this for all datasets. Each full cycle consists of 2*N epochs, where N is the number of datasets. Each cycle equates to one epoch in baseline training. The teacher model's weights were updated using an exponential moving average with a momentum of 0.80 after every epoch. Performance of the model was assessed in challenging tasks, like segmenting small and unique organs, and its effectiveness examined in learning in the presence of overlapping or unique labels.

Results and Analysis: The study demonstrated that the framework, which integrates knowledge from various datasets improved overall performance. This allowed for effective knowledge sharing across different datasets.

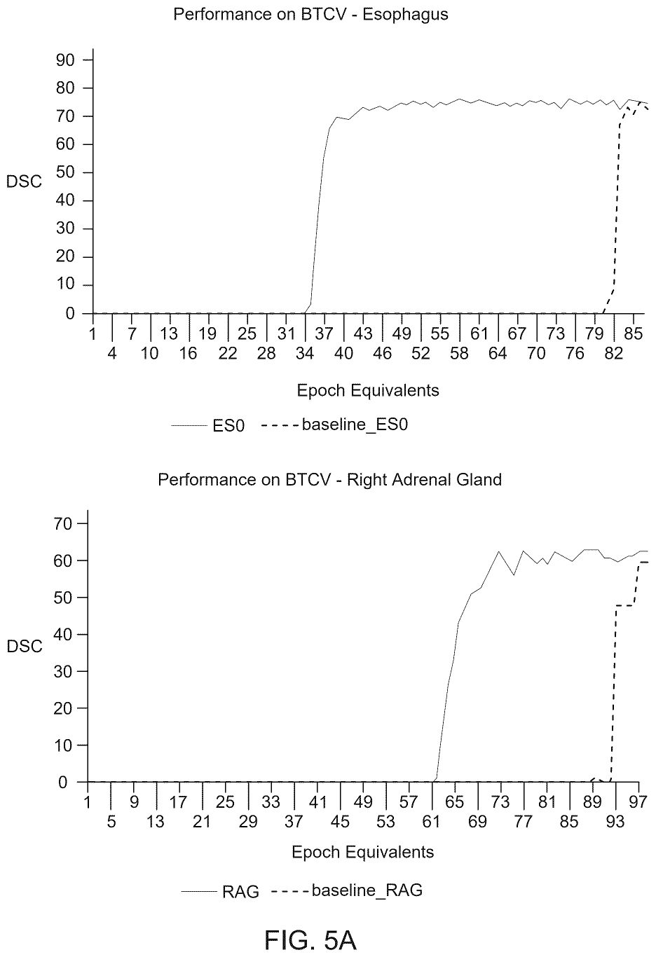

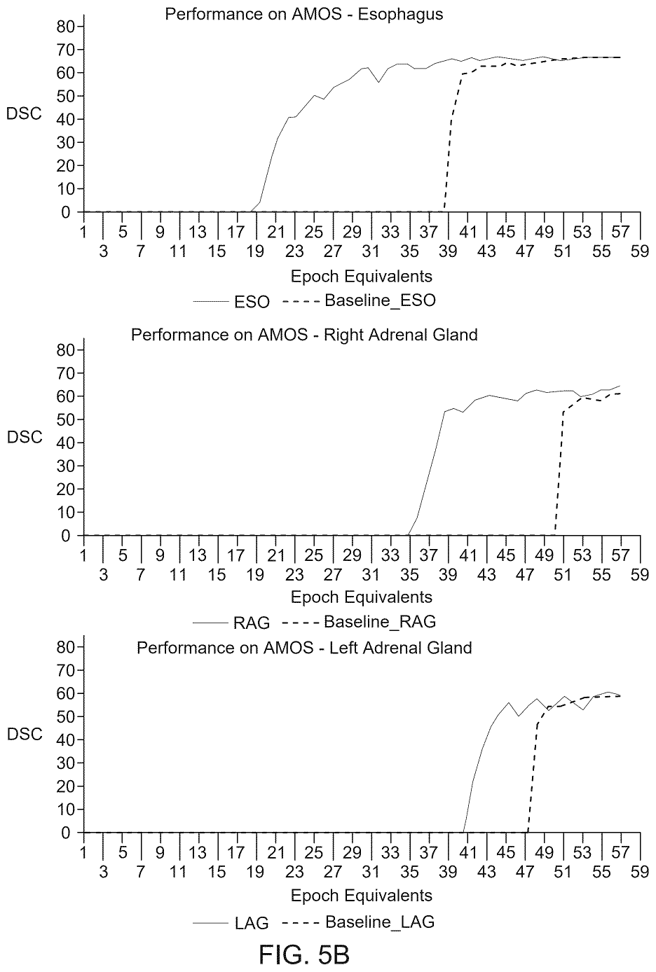

The model excelled on tasks with overlapping labels, such as LiTS and Abdomen CT1K, despite variations in label indices. It improved at a slower yet steady pace on tasks with many unique labels. FIGS. 5A and 5B demonstrate that the model improved notably in identifying smaller organs during pre-training and performed well on unique labels in the AMOS dataset. FIGS. 5A and 5B compare a single-task baseline model trained on one dataset with the model pre-trained on four datasets. The model demonstrated faster learning, even for smaller organs like the esophagus and adrenal glands, due to its extensive learning from combined datasets. Comparisons indicated the pre-training results were more consistent than baseline models, effectively managing heterogeneous datasets. Progress on unique labels in the BTCV dataset was slower due to limited training data; however, the model consistently improved on these tasks, balancing learning to avoid overfitting to fast-converging tasks while enhancing performance on slow-progressing ones.

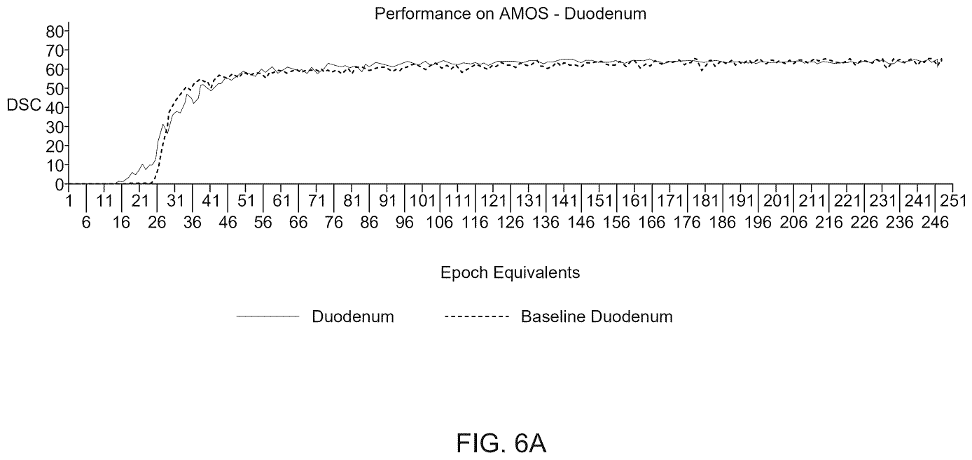

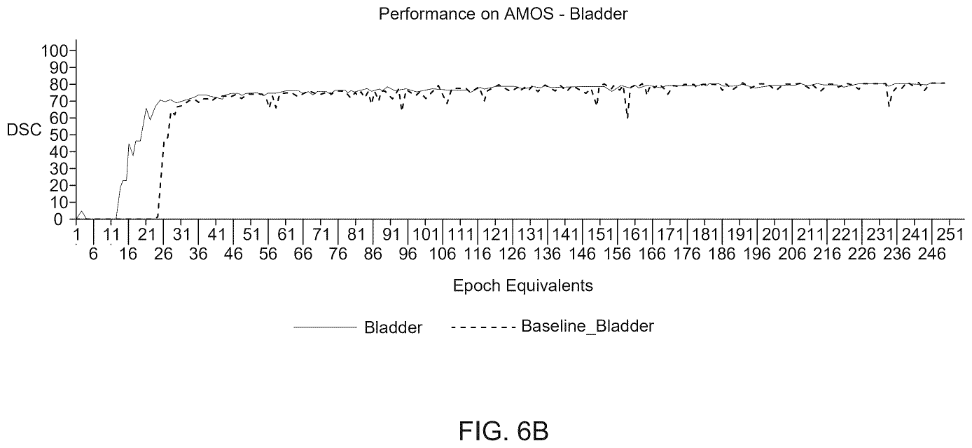

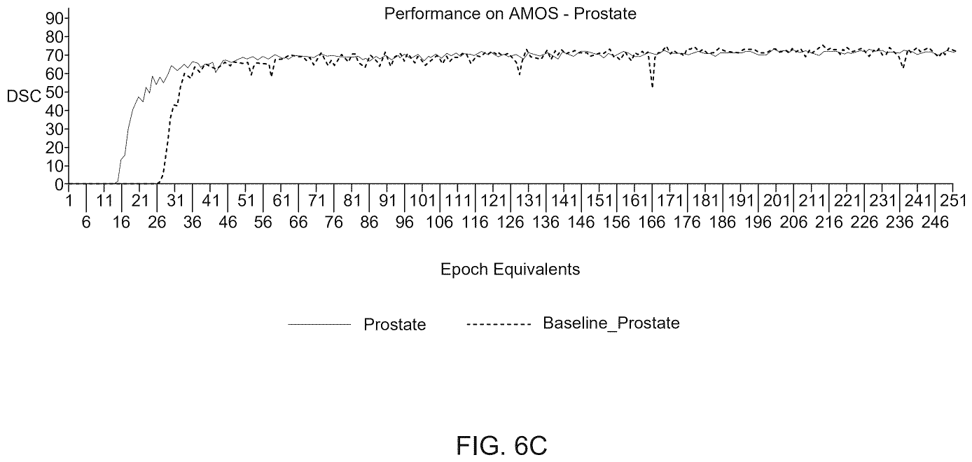

FIGS. 6A, 6B, and 6C compare a single-task baseline model trained on the AMOS dataset with the pre-trained model trained on four datasets. The model learned two out of three unique organs in the AMOS dataset more quickly and showed more consistent performance, demonstrating robustness against noisy updates and effective handling of unique labels with sufficient training data.

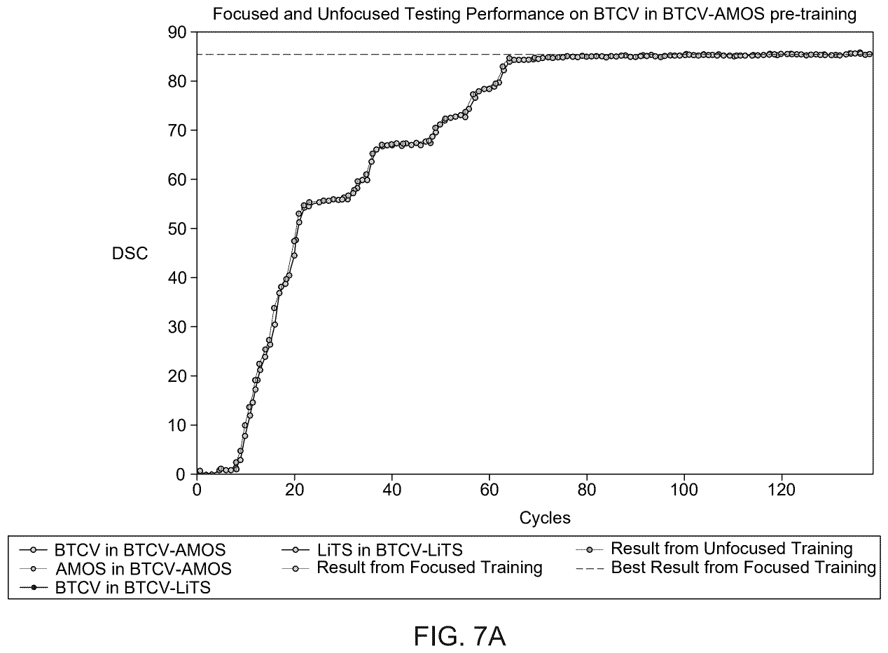

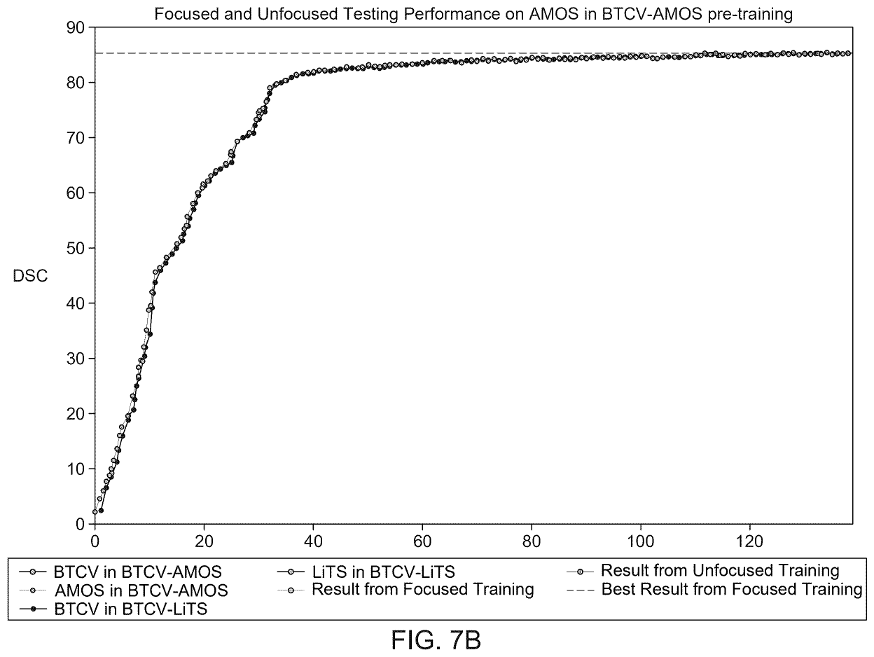

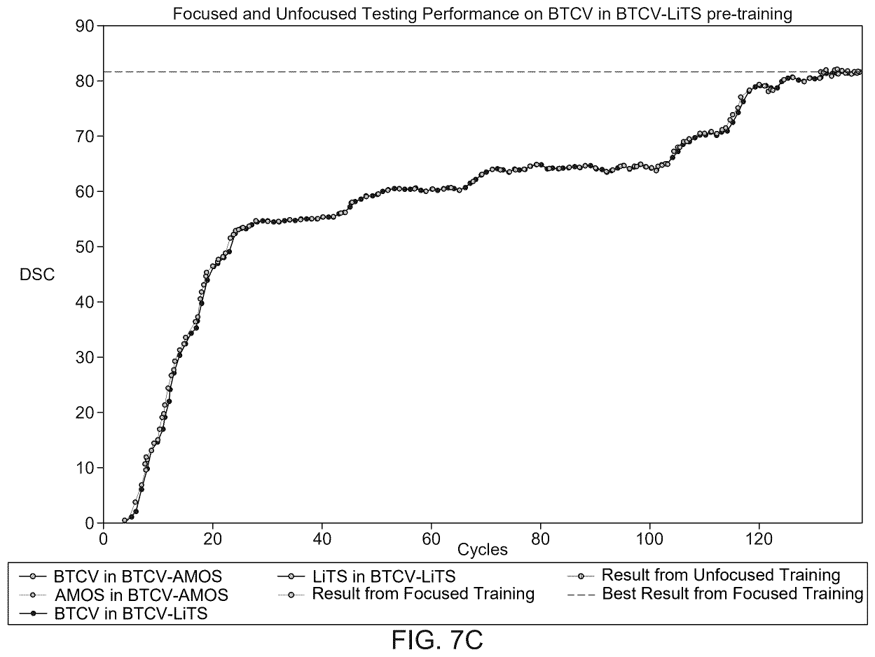

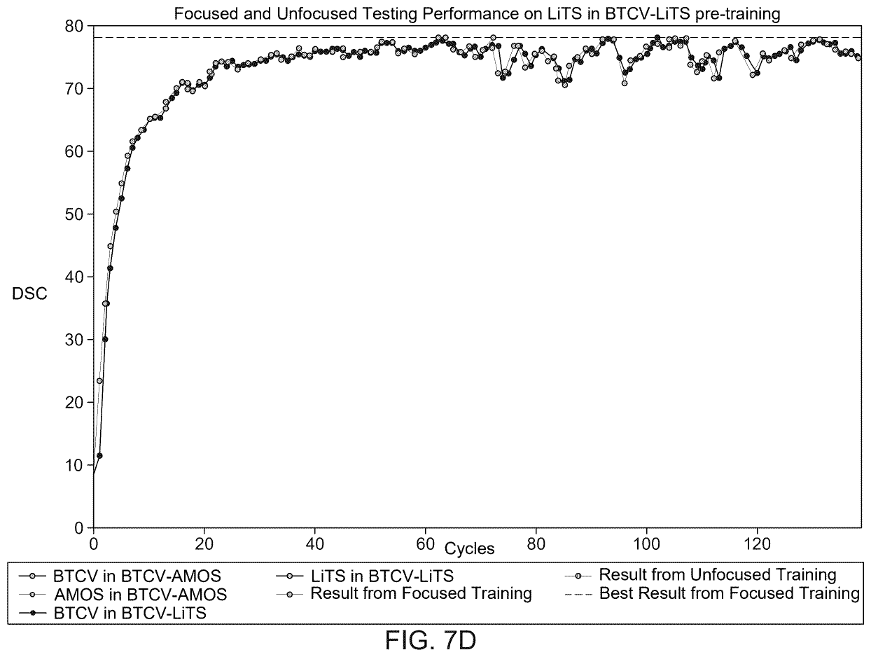

With reference to FIGS. 7A, 7B, 7C and 7D, in experiments with dataset pairs, such as BTCV-AMOS and BTCV-LiTS, the model performed better on BTCV when pre-trained on BTCV-AMOS due to more shared labels. Despite initially learning slow with BTCV-LiTS, the model showed consistent improvement. This confirms that knowledge transfer between tasks can enhance performance, showcasing the framework's effectiveness in creating shared representations without requiring shared labels. FIGS. 7A-7D illustrate the cross-task learning observed in two experiments. In the first experiment, the model was pre-trained on the BTCV and AMOS datasets, while in the second experiment, it was pre-trained on BTCV and LiTS. The model improved faster on the BTCV dataset when trained with AMOS, likely due to the advantage of shared labels between the two datasets. In the second scenario, the model learned 13 out of 14 BTCV labels from limited training scans. Despite this, performance consistently improved on each task after training the model on the other dataset in both experiments.

### 4.4.3 Boosting Framework Offers Superior Generalizable Representations

Experimental Setup: This experiment aimed to evaluate the adaptability of shared representations learned during pre-training on known and unknown datasets, as well as the data efficiency of the disclosed embodiments.

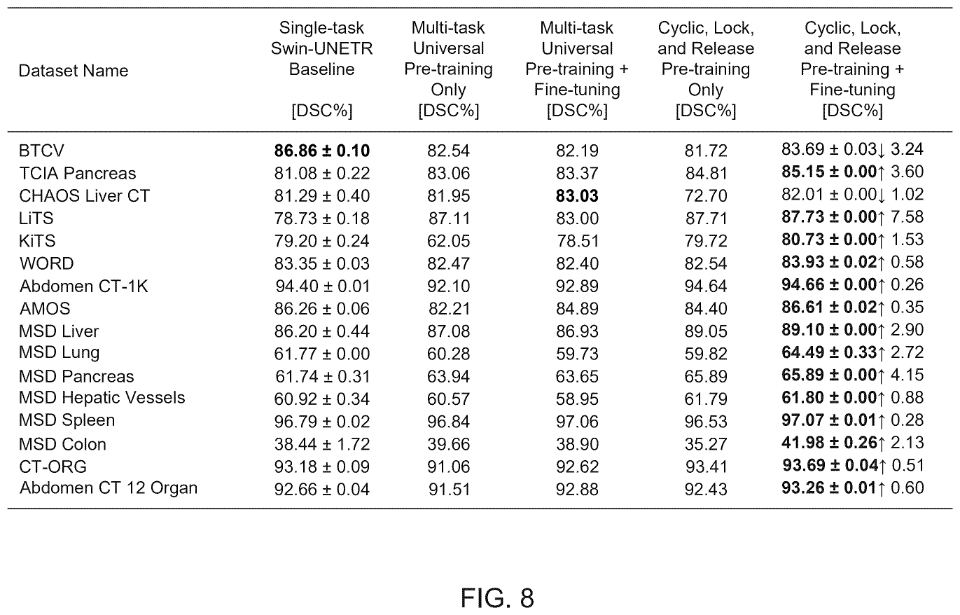

With reference to Table 2 presented in FIG. 8, experiments used the model, which was pre-trained on all 16 datasets from Liu et al. along with the CLIP-driven Universal model, which was also pre-trained on those 16 datasets using a patch size of 128×128×128. FIG. 8 presents performance scores for the model, pre-trained on 16 public datasets for 200 epochs. In comparison, single-task Swin UNETR models were trained for 500 epochs, and the multi-task CLIP-driven Universal model was pre-trained for 300 epochs. The model outperformed half of the single-task baselines and surpassed the CLIP-driven Universal model on 11 of 16 datasets after 200 epochs. After fine-tuning, it significantly outperformed both baseline models on 15 of the 16 datasets. After the pre-training phase, both models were fine-tuned on each of the 16 datasets and their performance compared to that of single-task Swin UNETR models, which were fine-tuned independently on each of those 16 datasets for 500 epochs. All models were initialized with the same self-supervised learning backbone weights from Hatamizadeh et al. and were trained with identical hyperparameters. The model and the CLIP-driven Universal model underwent pre-training for 200 and 400 epochs, respectively, as they outperformed most of the Swin UNETR baselines with just that amount of pre-training. Both models were subsequently fine-tuned for up to 500 epochs with an early stopping criterion to ensure convergence. This is conducted to assess the effectiveness of the disclosed embodiments'approach in learning superior shared representations for known datasets.

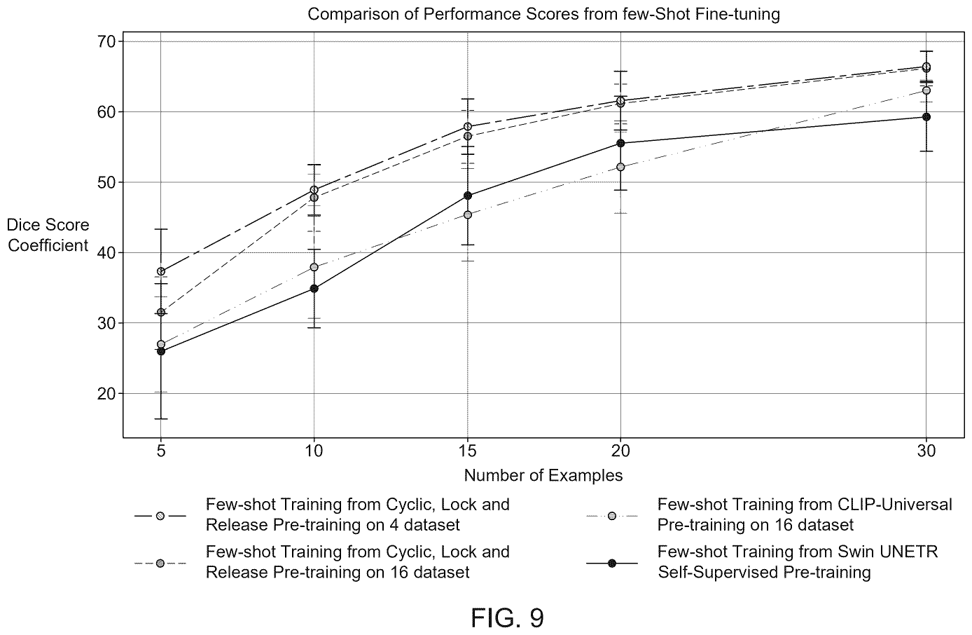

Additionally, CLIP-driven Universal and Swin UNETR were fine-tuned using few-shot examples from the previously unseen TotalSegmentator dataset, focusing on the “Organs” target task. These models were compared to the pre-trained models fine-tuned on the same TotalSegmentator dataset to assess the effectiveness of the approach in learning generalizable representations for unknown datasets. FIG. 9 presents performance scores from the few-shot fine-tuning experiment on the TotalSegmentator dataset for the Organs task. Two baseline models were fine-tuned: the Swin UNETR model initialized with self-supervised learning weights, and a CLIP-driven Universal model pre-trained on 16 datasets for 300 epochs. Both versions of the model were also fine-tuned, as noted in Sec. 4.4.1: one pre-trained on four datasets for 300 epochs and another on all 16 datasets for 200 epochs. Both versions significantly outperformed the baseline models, highlighting their strong generalizability and data efficiency.

Results and Analysis: The pre-trained model outperformed 8 out of 16 single-task baseline models and surpassed the CLIP-driven Universal model on 11 out of 16 datasets by a larger margin after just 200 training cycles. The method surpassed the Swin UNETR and CLIP-driven Universal models on most tasks, even with fewer pre-training epochs, achieving better results around the 200th epoch. After fine-tuning, the model exceeded the performance of both the single-task Swin UNETR baselines and the fine-tuned CLIP-driven model on 15 out of 16 datasets. Although performance on the BTCV and CHAOS datasets was slightly lower, the overall results remained competitive, indicating the model's capacity for effective shared representations. This underperformance can be attributed to the limited number of pre-training samples, with only 24 samples for BTCV and 14 samples for CHAOS. The model's performance on the unique organ in the BTCV dataset was slightly suboptimal, likely due to its underrepresentation during pre-training. However, the experiments revealed its remarkable ability to adapt to unfamiliar environments with out-of-domain datasets even fine-tuned on limited data. As illustrated in FIG. 9, the longer pre-training duration resulted in better performance than the version trained for 100 fewer epochs. Both versions surpassed the Swin UNETR model with self-supervised weights and the CLIP-driven Universal model, even when trained on only five samples.

### 5. Conclusion

MedNeXt and U-Mamba_Bot were identified as strong contenders for 3D segmentation tasks, especially with limited data. An end-to-end model was developed using a robust representation learning framework to enhance 3D segmentation. This framework employs diverse expert annotations and captures contextual relationships among labels, performing effectively across various tasks without bias. It supports continual learning through a mean teacher network, allowing adaptation to new tasks while preserving knowledge. Pre-trained on 16 public datasets with 3,000 CT scans annotated for 25 organs and 6 tumors, the model outperformed the single-task SwinUNETR and the multi-task CLIP-driven Universal. It also showed superior generalization and data efficiency when fine-tuned on the TotalSegmentator dataset, surpassing the baselines even with few-shot examples.

What is claimed is:

1. A computer-implemented method for training a deep learning model, comprising:
receiving a plurality of heterogeneously labeled three-dimensional image data sets; and
learning features of images in the plurality of heterogeneously labeled three-dimensional image data sets, via a three-dimensional image segmentation framework that operates using a single, shared, image encoder, comprising:
performing, via the image encoder, a classification task to learn image-level features in the images,
performing, via the image encoder, a segmentation task to learn pixel-level features in the images, and
performing, via the image encoder, a localization task to learn regional-level features in the images.

2. The computer-implemented method of claim 1, wherein receiving the plurality of heterogeneously labeled three-dimensional image data sets comprises receiving a plurality of heterogeneously and overlapping labeled three-dimensional image data sets.

3. The computer-implemented method of claim 1 wherein learning features of the images in the plurality of heterogeneously labeled three-dimensional image data sets, via the three-dimensional image segmentation framework that operates using the single, shared, image encoder, comprises learning features of the images that are shared among each of the image-level features, the pixel-level features, and the regional-level features.

4. The computer-implemented method of claim 3, wherein learning features of the images in the plurality of heterogeneously labeled three-dimensional image data sets, via the three-dimensional image segmentation framework that operates using the single, shared, image encoder, comprises learning features of the images that are shared among each of the classification task, the segmentation task, and the localization task.

5. The computer-implemented method of claim 1, wherein learning features of the images in the plurality of heterogeneously labeled three-dimensional image data sets, via the three-dimensional image segmentation framework that operates using the single, shared, image encoder, comprises learning features of the images in the plurality of heterogeneously labeled three-dimensional image data sets, via the three-dimensional image segmentation framework that operates using the single, shared, Swin-B image encoder.

6. The computer-implemented method of claim 1, further comprising learning, via a plurality of linear classifiers, image-level features of the images for a respective plurality of classification tasks.

7. The computer-implemented method of claim 1, further comprising learning, via a decoder with a plurality of segmentation task-specific heads, pixel-level features of the images for a respective plurality of segmentation tasks.

8. The computer-implemented method of claim 7, wherein learning pixel-level features of the images for the respective plurality of segmentation tasks, comprises performing, via a segmentor employing an Uper-Net architecture, the respective plurality of segmentation tasks.

9. The computer-implemented method of claim 1, further comprising learning, via a transformer image encoder and a plurality of transformer decoders with localization task-specific heads, regional-level features of the images for a respective plurality of localization tasks.

10. The computer-implemented method of claim 9, wherein learning regional-level features of the images for the respective plurality of localization tasks comprises performing, via a localizer employing a DEtection TRansformer with Improved deNoising anchor boxes (DINO) architecture, the respective plurality of localization tasks.

11. The computer-implemented method of claim 1, wherein learning features of images in the plurality of heterogeneously labeled three-dimensional image data sets, comprises iteratively learning features of images in the plurality of heterogeneously labeled three-dimensional image data sets, wherein each iteration comprises performing the classification task to learn image-level features in the images, the segmentation task to learn pixel-level features in the images, and the localization task to learn regional-level features in the images.

12. The computer-implemented method of claim 1, wherein performing the classification
task to learn image-level features in the images, the segmentation task to learn pixel-level features in the images, and the localization task to learn regional-level features in the images, comprises:
performing in a first, lock mode, stage, the classification task to learn image-level features in the images, the segmentation task to learn pixel-level features in the images, and the localization task to learn regional-level features in the images, using only a random portion of the plurality of heterogeneously labeled three-dimensional image data sets; and
performing, in a second, release mode, stage, the classification task to learn image-level features in the images, the segmentation task to learn pixel-level features in the images, and the localization task to learn regional-level features in the images using all the plurality of heterogeneously labeled three-dimensional image data sets.

13. The computer-implemented method of claim 1, wherein learning features of images in the plurality of heterogeneously labeled three-dimensional image data sets, via the three-dimensional image segmentation framework that operates using a single, shared, image encoder, comprises learning features of images in the plurality of heterogeneously labeled three-dimensional image data sets, via the three-dimensional image segmentation framework employing a student-teacher learning paradigm.

14. The computer-implemented method of claim 13, wherein employing the student-teacher learning paradigm comprises:
initializing a teacher model and a student model each having an identical architecture and weights;
updating the weights of the student model using training methods via loss backpropagation;
updating the weights of the teacher model using an exponential moving average; and
fine tuning the deep learning model via the teacher model.

15. A system comprising:
a memory to store instructions;
a processor to execute the instructions stored in the memory to perform the following operations:
receiving a plurality of heterogeneously labeled three-dimensional image data sets; and
learning features of images in the plurality of heterogeneously labeled three-dimensional image data sets, via a three-dimensional image segmentation framework that operates using a single, shared, image encoder, comprising:
performing, via the image encoder, a classification task to learn image-level features in the images,
performing, via the image encoder, a segmentation task to learn pixel-level features in the images, and
performing, via the image encoder, a localization task to learn regional-level features in the images.

16. The system of claim 15, further comprising instructions stored in the memory to perform the following operations:
learning, via a plurality of linear classifiers, image-level features of the images for a respective plurality of classification tasks;
learning, via a decoder with a plurality of segmentation task-specific heads, pixel-level features of the images for a respective plurality of segmentation tasks; and
learning, via a transformer image encoder and a plurality of transformer decoders with localization task-specific heads, regional-level features of the images for a respective plurality of localization tasks.

17. The system of claim 15, wherein performing the classification task to learn image-level features in the images, the segmentation task to learn pixel-level features in the images, and the localization task to learn regional-level features in the images, comprises:
performing in a first, lock mode, stage, the classification task to learn image-level features in the images, the segmentation task to learn pixel-level features in the images, and the localization task to learn regional-level features in the images, using only a random portion of the plurality of heterogeneously labeled three-dimensional image data sets; and
performing, in a second, release mode, stage, the classification task to learn image-level features in the images, the segmentation task to learn pixel-level features in the images, and the localization task to learn regional-level features in the images using all the plurality of heterogeneously labeled three-dimensional image data sets.

18. A non-transitory computer readable storage media having instructions stored thereupon that, when executed by a system having at least a processor and a memory therein, cause the processor to perform the following operations:
receiving a plurality of heterogeneously labeled three-dimensional image data sets; and
learning features of images in the plurality of heterogeneously labeled three-dimensional image data sets, via a three-dimensional image segmentation framework that operates using a single, shared, image encoder, comprising:
performing, via the image encoder, a classification task to learn image-level features in the images,
performing, via the image encoder, a segmentation task to learn pixel-level features in the images, and
performing, via the image encoder, a localization task to learn regional-level features in the images.

19. The non-transitory computer readable storage media of claim 18, further comprising instructions stored in the memory to perform the following operations:
learning, via a plurality of linear classifiers, image-level features of the images for a respective plurality of classification tasks;
learning, via a decoder with a plurality of segmentation task-specific heads, pixel-level features of the images for a respective plurality of segmentation tasks; and
learning, via a transformer image encoder and a plurality of transformer decoders with localization task-specific heads, regional-level features of the images for a respective plurality of localization tasks.

20. The non-transitory computer readable storage media of claim 18, wherein performing the classification task to learn image-level features in the images, the segmentation task to learn pixel-level features in the images, and the localization task to learn regional-level features in the images, comprises:
performing in a first, lock mode, stage, the classification task to learn image-level features in the images, the segmentation task to learn pixel-level features in the images, and the localization task to learn regional-level features in the images, using only a random portion of the plurality of heterogeneously labeled three-dimensional image data sets; and
performing, in a second, release mode, stage, the classification task to learn image-level features in the images, the segmentation task to learn pixel-level features in the images, and the localization task to learn regional-level features in the images using all the plurality of heterogeneously labeled three-dimensional image data sets.
